(19) United States
(12) Patent Application Publication
(10) Pub. No.: US 2025/0069106 A1
(43) Pub. Date: Feb. 27, 2025

(54) BLOCKCHAIN GAMING PLATFORM

(71) Applicants: Hugh Knight, Surrey (CA); Haniff Knight, Surrey (CA)

(72) Inventors: Hugh Knight, Surrey (CA); Haniff Knight, Surrey (CA)

(21) Appl. No.: 18/454,335

(22) Filed: Aug. 23, 2023

(51) Int. Cl. A63F 13/792; G06Q 20/36; G06Q 20/38

(52) U.S. Cl. CPC A63F 13/792; G06Q 20/3678; G06Q 20/381; G06Q 20/3825; G06Q 20/3829; G06Q 20/389

(57) ABSTRACT

A system and method for converting between in-game digital assets and cryptocurrency tokens on a distributed ledger. Transaction message are created and digitally signed by users and broadcast for incorporation into the distributed ledger. Assets may be fungible or non-fungible tokens implemented as Smart Contracts on a blockchain. Assets may represent avatars, game currency, tools earned in a game. Certain assets may be transferred from one game to another game via the ledger.

### FIELD

The present invention is relevant to electronic gaming and digital currency conversion, particularly with respect to decentralized conversion and storage of same.

### BACKGROUND

Electronic gaming platforms currently enable large numbers of users to remotely access them and play video and gambling games. Users can earn or purchase virtual, in-game currency on the gaming platform, which can be used to improve a user's avatar, alter an avatar's appearance, or gamble the virtual currency itself with other users. Given the benefit of these virtual currencies to users and competitive nature of the games, there is a need to strictly protect and monitor users' virtual currency. In some cases, users have hacked the system to award themselves huge amounts of virtual currency and in-game assets.

Moreover, once a user finishes a game, their assets are useless as they may only be used within that single game. There is no mechanism to exchange virtual currency to another gaming platform or monitor how many assets the user actually owns.

### SUMMARY

In accordance with a first aspect of the invention there is provided a system comprising: a gaming server in communication with multiple user-devices for playing an electronic game; a distributed ledger accessible by multiple computing nodes; and a transaction module. The transaction module comprises instructions for: receiving a transaction request for converting between in-game, digital assets and cryptocurrency on the distributed ledger; creating and digitally signing a transaction message corresponding to the transaction request; and broadcasting the transaction message to the computing nodes, for incorporation into the distributed ledger.

The transaction module may comprise further instructions to communicate a success or failure of the transaction request to the gaming server, in order to update the digital assets on a private ledger of the gaming server.

The transaction message may be a smart contract.

The transaction module may comprise further instructions to determine a conversion rate between the digital assets and cryptocurrency.

The distributed ledger may be a blockchain.

The distributed ledger may be an Ethereum-based blockchain.

The cryptocurrency may be an ERC20 token.

The digital asset may be a non-fungible asset and the cryptocurrency may be an ERC721-compliant token.

The transaction message may be digitally signed using private keys of the gaming server and a user making the transaction request.

The digital assets may be one of a: in-game currency, game avatar, avatar skin, avatar tool, or game environment.

The digital assets may be earned through user game play or purchased with fiat currency or cryptocurrency.

The transaction module may be a plug-in or SDK run by the gaming server.

The transaction module may be run on a transaction server in communication with the gaming server.

The transaction message may convert digital assets to cryptocurrency.

The transaction message may convert cryptocurrency to digital assets.

In accordance with a second aspect of the invention there is provided a computer-implemented method of converting between in-game digital assets and cryptocurrency tokens on a distributed ledger. The method comprises: receiving a request to convert an amount of digital assets in a gaming platform to cryptocurrency in a distributed ledger; determining a conversion rate to calculate an amount of cryptocurrency; creating a transaction message identifying the amount of cryptocurrency, the recipient of the cryptocurrency, and the game platform sending the cryptocurrency; requesting the recipient and gaming platform digitally sign the message using their private keys broadcasting the digitally signed transaction message to a plurality of mining computers.

The message may identify conditions for processing the transaction.

The method may convert between cryptocurrency tokens and in-game digital assets on a second gaming platform different from the first gaming platform.

In accordance with a third aspect of the invention there is provided a computer-implemented method for gaming transactions. The method comprises: determining that a user is eligible for an in-game, non-fungible, digital asset based on user game play; creating a transaction message including data about the non-fungible digital asset and public identifier of the user; and broadcasting the transaction message to multiple computing nodes to incorporate the transaction offer into a distributed ledger.

The message may include an amount of cryptocurrency to be sent by the user in exchange for the non-fungible digital asset.

In accordance with a fourth aspect of the invention there is provided a computer-implemented method for transacting digital assets on a blockchain accessed by multiple gaming platforms. The method comprises: exporting a first in-game digital asset from a first game platform to a token on the blockchain; importing the token to a second in-game digital asset on a second game platform, different from the first platform; and interpreting metadata in the token into attributes of the digital asset.

The token may be structured as a Smart Contract comprising functions for handling ownership of the token and metadata representing attributes of the digital assets.

Exporting the first in-game digital asset may comprise setting metadata of the token based on attributes of said digital asset.

In accordance with a fifth aspect of the invention there is provided a computing system for transacting digital assets between computer games, comprising: a blockchain data structure distributed amongst a multiple computing nodes; token data structure storing metadata and instructions for processing transactions of the token on the blockchain; and one or more gaming platforms, each platform comprising at least one processor and instructions. The instructions are configured to: broadcast an export request from a user to the multiple computing nodes, the export request comprising a request to update a specified token's metadata with data representing attributes of a digital asset of a first game; broadcast an import request from the user to import the token's metadata to a second game, different from the first game; interpret the token's metadata as attributes of a second digital asset in the second game; and operate the second game for the user using the second digital asset.

The import and export requests may be cryptographically signed by the user, the user registered as an owner of the token.

The system and method may comprise determining eligibility of user for in-game rewards, experience, or digital assets based on past transaction of the token.

The system and method may comprise interpreting attributes of the digital assets in the second game based on past transaction of the token.

The system and method may comprise locking the token after the token is imported to the second game by setting a second ownership variable to the public key associated with that second game, until the second game provides a signed request to unlock the token.

In accordance with a sixth aspect of the invention there is provided a cryptographic token for transacting on a blockchain comprising: metadata representing attributes of digital assets in a game; an ownership variable storing the public key of a user; a second ownership variable storing the public key associated with the game; and functions for importing and exporting the metadata to and from games.

The token may comprise functions for updating the ownership variables and metadata.

### DRAWINGS

Embodiments of the invention may be described by the following figures, where like numbers refer to like items.

FIG. 1 is a block illustrating a system allowing users the ability to convert in-game, digital assets.

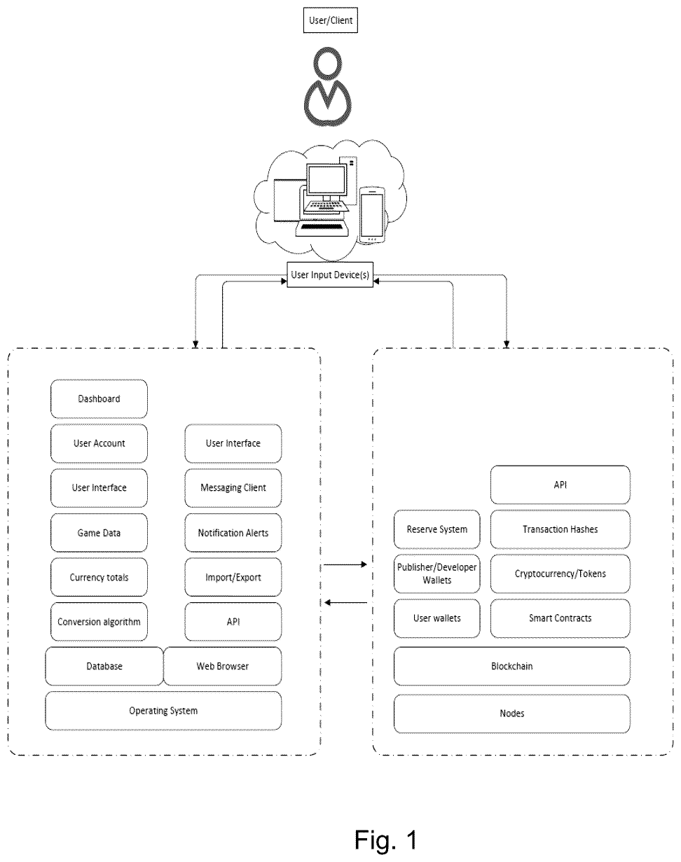

FIG. 2 is a flow diagram of the export conversion process in one embodiment.

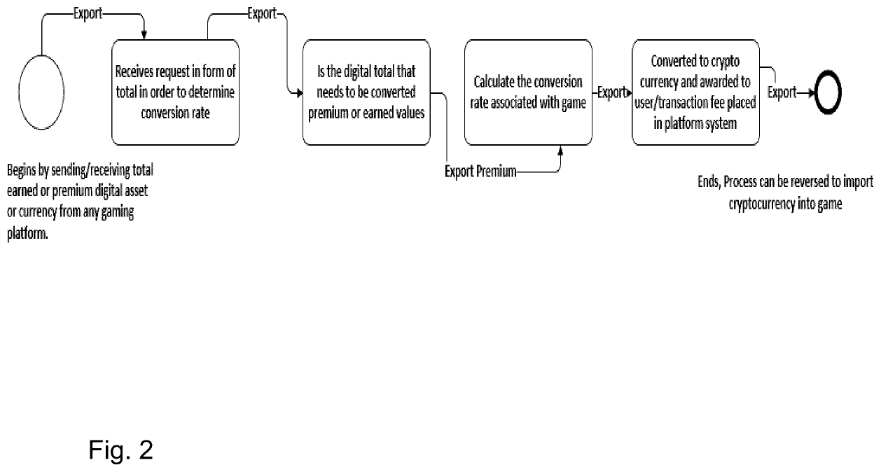

FIG. 3 is a flow diagram of the import conversion process in one embodiment.

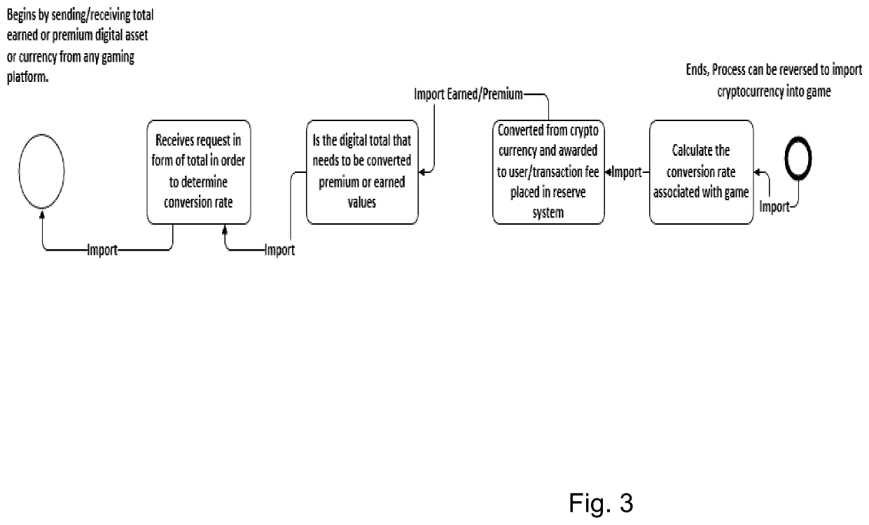

FIG. 4 is a flow diagram illustrating the transaction from game to transaction platform to blockchain.

FIG. 5 is a flow diagram illustrating a user account modification for fungible and non-fungible component in one embodiment.

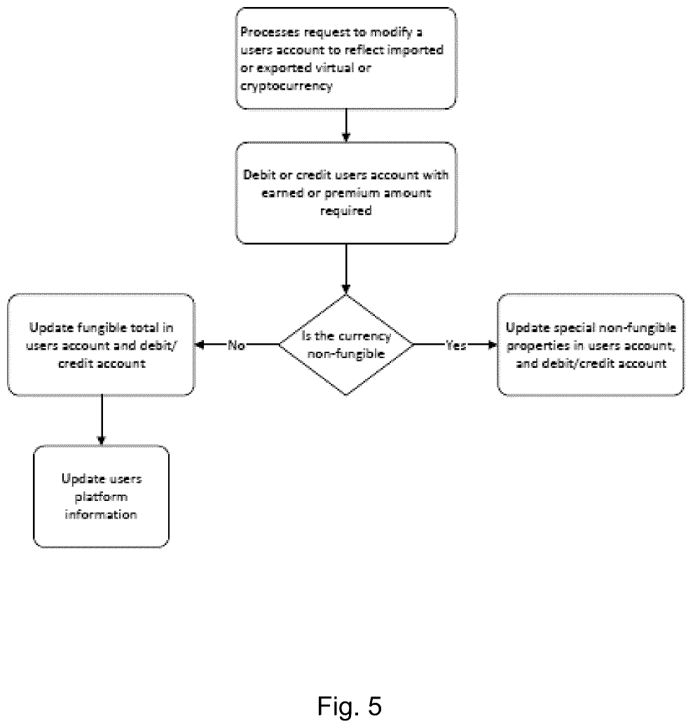

FIG. 6 is a flow diagram illustration a purchase or award of a non-fungible asset.

FIG. 7 is a diagram illustrating the process for exporting digital assets to the distributed ledger via a transaction on a web or mobile application.

FIG. 8 is a diagram illustrating the process for importing digital assets from the distributed ledger via a transaction on a web or mobile application.

FIG. 9 is a diagram illustrating the process for exporting digital assets to the distributed ledger directly using a SDK on the game server.

FIG. 10 is a diagram illustrating the process for importing digital assets to the distributed ledger directly using a SDK on the game server.

FIG. 11 is a diagram illustrating the process for transacting non-fungible assets between game servers.

FIG. 12 is a diagram illustrating transfer from a digital wallet to a first game server

FIG. 13 is a diagram illustrating transfer from a first server to a second server,

FIG. 14 is a function description of an ERC721 Contract.

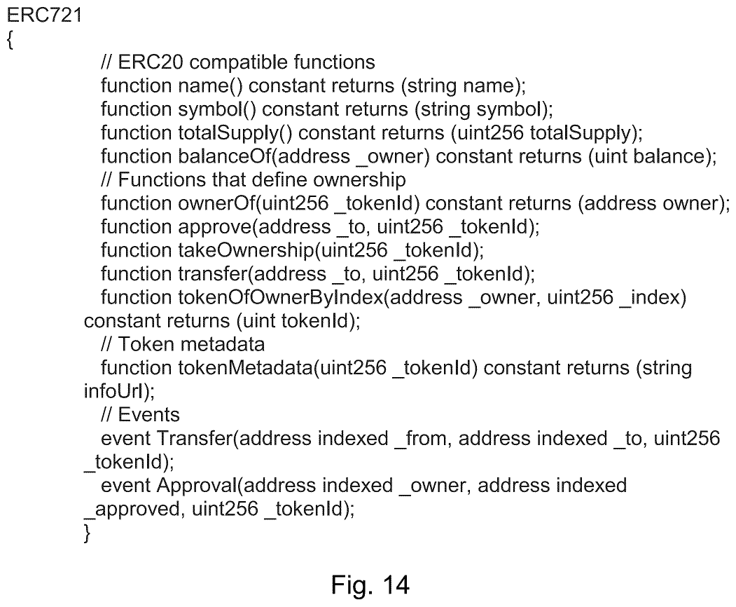

FIG. 15 is a system diagram for communication amongst devices, servers, and a distributed ledger.

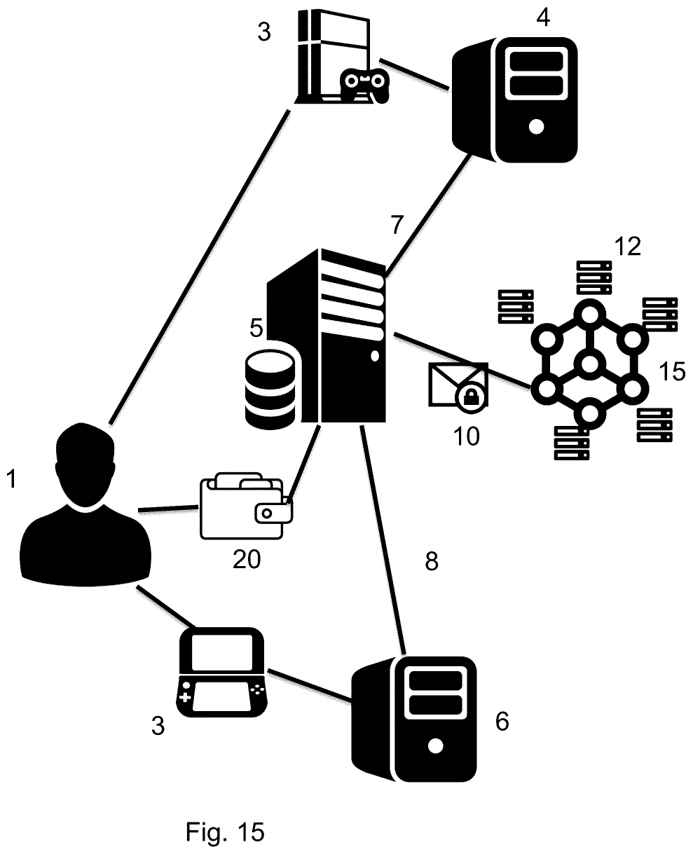

### DESCRIPTION

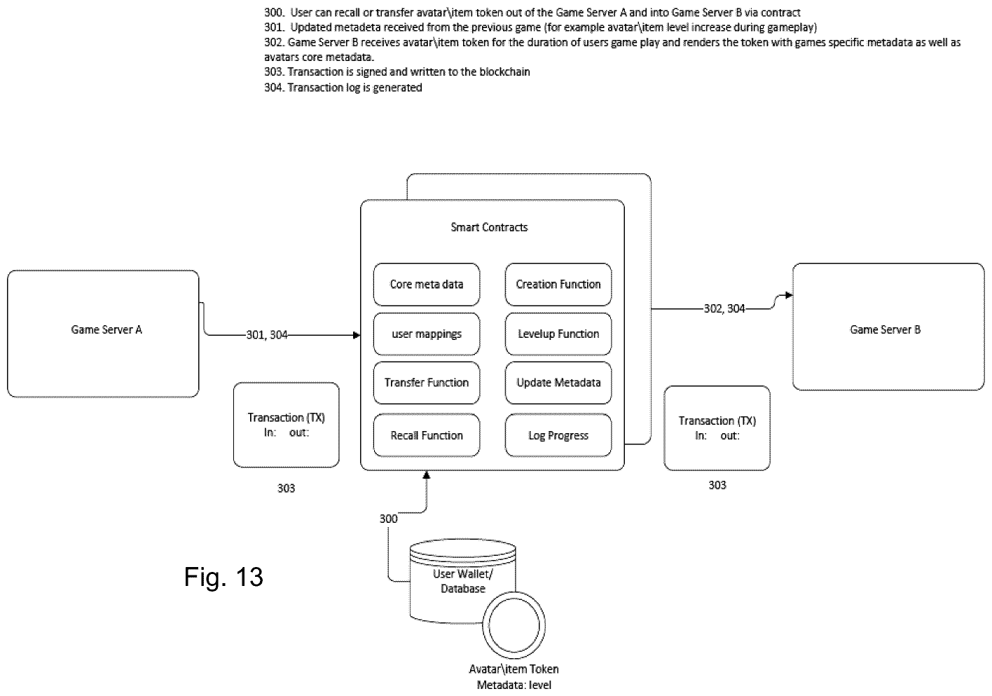

The invention provides a system, method, platform and software for conversion of in-game, virtual currency to a cryptocurrency on a decentralized ledger. As shown in FIG. 13 the system comprises: one or more gaming servers (4,6), a decentralized ledger (15) operable by a plurality of computing nodes (12); transaction server/software (5) for communicating encrypted messages (10) between the gaming server and the decentralized ledger; user devices (3) in communication with the gaming servers, and user wallets (20). The gaming servers may send export conversion request 7 or import conversion requests 8, via the software 5 to the ledger 15.

### Game Platforms

A game platform is a system, comprising game consoles, servers, private ledgers, software and processors for making games accessible to users and managing user accounts and digital assets balances. A gaming server 4, 6 hosts software for playing electronic games, such as video game or gambling game. These servers may be operated by the publisher of gaming software or outsourced to distributors such as Google™ Play, iTunes™ and Steam™. The gaming platform may use user-devices 3, such as smartphones and game consoles, to process the game software and simply send updates to the server or the user device may be a dumb terminal that provide a UI for the game software largely processed on the server. A gaming server may host multiple games and games may be repeat hosted by multiple servers for load balancing and reducing latency.

Digital assets may be virtual currencies (e.g. gems, gold, coins, New York Dollars, ‘credits’), avatars, avatar skins, avatar tools, or game environments. These assets are normally only relevant to a single game and held within that game's platform They are neither Fiat currency, nor exchangeable outside of the respective game. In-game, digital assets may be earned by user achievements, simply playing and obtaining points (earned) or purchased with fiat currency (premium). The assets may be fungible (e.g. game coins that are indistinguishable and exchangeable for another coin or easily traded for another assets) or non-fungible (e.g. special or even unique game rewards that are distinguishable from other assets and not easily traded for other assets).

Normally the gaming server, via its game software, may issue or sell digital assets solely for use in that game, potentially without limit or traceability. In the present system, each gaming server maintains a private ledger of users and their assets, optionally including pointers to transactions for these assets on the decentralized ledger. This allows the users to use assets in-game quickly, without the gaming server needing to constantly reference and update the decentralized ledger. At the same time, there is traceability of the assets and assurance to the gaming community that the totals are correct.

The user plays a game using a variety of devices. When desired, the user initiates a request to convert their digital, in-game assets to the distributed ledger. The initiation may be done via the game console or using a digital wallet. The game platform check whether the request is valid from its own rules, either returning an error or passing the request to the transaction module. The process downstream of the game is discussed below.

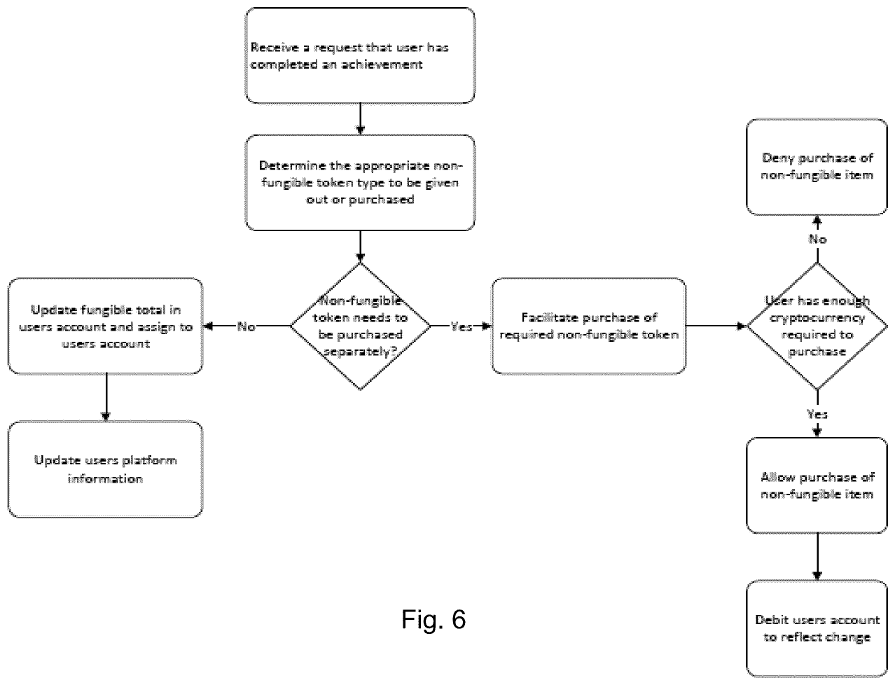

In addition to earning fungible digital assets through simple game play, the gaming system may reward certain in-game achievements with non-fungible assets, which may be rare, unique or non-exchangeable with any other asset. For examples, certain in-game tournaments and events may provide winning users with unusual avatar skins or tools. Awarding this asset may be made through a special smart contract programmed to transfer non-fungible tokens of a certain type to a winning user's account on the distributed ledger. FIG. 6 is a flowchart for awarding a non-fungible asset using a distributed ledger. The gaming platform creates a reward event and determines a corresponding non-fungible token type. The transaction module converts this to a smart contract for that token type, where the sender is the particular game platform and the recipient is the winning user (identified by their public key). A determination is made from the contract code as to whether this non-fungible token requires user payment. If payment is required and agreed by the user (verified by their digital signature), then the contract transfers, within the distributed ledger, a cryptocurrency token (such as Ether) from the user to the game system's account. The user's account on the gaming platform is updated to include the non-fungible asset.

### User Devices and Wallets

Each user may have an account (i.e. username and password) with the gaming platform and an associated pair of public and private keys. Each user may also control a digital or cryptocurrency wallet, which may be programmed to read the balance of digital assets and cryptocurrency from the game's private ledger and the distributed ledger. The wallet 20 may be used for multiple game systems 4,5 and may be installed on the user-device 3 or on the transaction server 5. The wallet is software or hardware that securely stores a pair of associated keys, digitally signs transactions with the private key and views transactions on the distributed ledger with regard to the public key. Each wallet is programmed to connect to the particular game systems to determine in-game assets and request conversions.

Preferably the wallets are smart wallets, being programmed as smart contracts on the distributed ledger.

### Distributed Ledger

A distributed ledger is a database accessible by multiple computers. Some of these computers, such as gaming servers and user wallets, only view the transactions and balances on the ledger, while other computers (often called mining nodes or miners) can amend the ledger and confirm amendments. The ledger may be permissioned, in which case only certain computers are given access or specific access.

The distributed ledger may be implemented as a blockchain, in which a set of transactions are compiled to form a block which references the previous block. This technology may be implemented using known blockchain technology, such as Ethereum or EOS. Ethereum not only allows sending cryptocurrency from one user to another, but also makes provisions for Smart Contracts and generic token mechanics. For example, fungible assets may be converted to ERC20-compliant or ERC223-compliant tokens and non-fungible assets may be converted to ERC721-compliant tokens. The skilled person will appreciate that these token and contract standards are exemplary and that new standards will emerge that may be used to provide transactions for new crypto tokens.

Known blockchain protocols may be applied to the present system, whereby proposed and signed transactions are broadcast by the transaction module to the multiple mining nodes. At least one of the nodes will run the blockchain rules on the proposed transaction, incorporate the transaction into a new block, run the code of the transaction, and provide some proof of work or proof of stake to the other nodes in order that the new block is accepted.

A reserve account holds tokens on the distributed ledger on behalf of certain actors such as game publishers and pays a drip bonus to certain large token holder

### Transaction Module

A Transaction Module operates between the gaming platform and the distributed ledger. This Module may reside on an intermediary server 5 called by the gaming platforms using APIs, which are converted to transaction requests and data queries for the ledger. Alternatively, the Transaction Module is provided as a Software Development Kit (SDK) implemented by the game platform and run on a gaming server 4,6, such that the game server can directly make transaction requests and data queries to the distributed ledger.

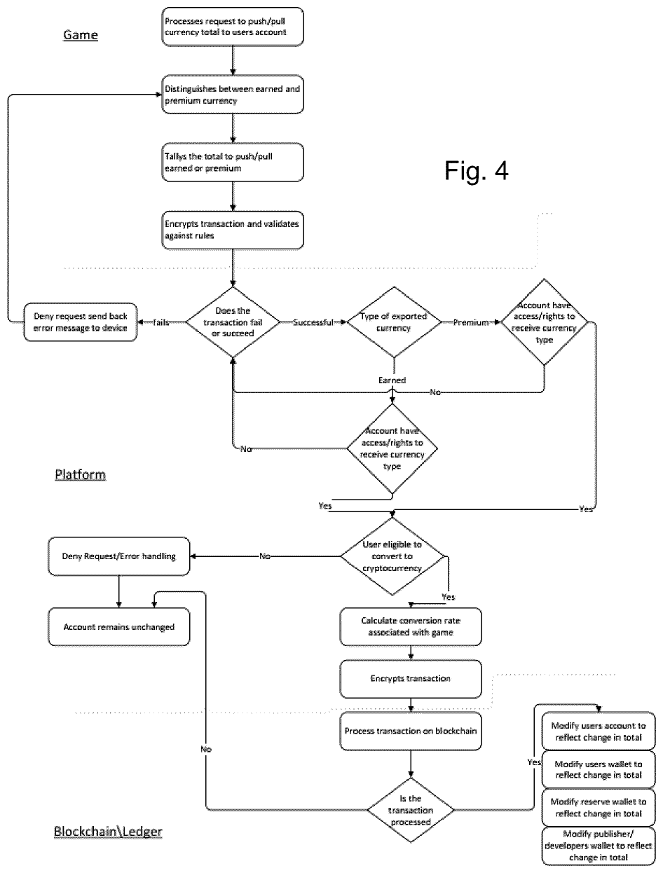

To initiate a conversion (importing or exporting), one of the user or gaming platform, makes a request to create a transaction for a stated quantity of a certain digital asset type. The Transaction Module determines the current, appropriate conversion rate and checks transaction limits and rules to return an error or creates a proposed transaction. The user and game accept this transaction be digitally signing it with their private keys. FIG. 4 provides a workflow of such a conversion. Signatures ensure that the transaction cannot be repudiated by either party.

Rules for transactions include:
The sender has enough of the digital asset or cryptocurrency to be sent.
The ledger records a previous transaction of a digital asset or cryptocurrency toward the current sender.
The sender has not already spent digital asset or cryptocurrency to be sent.
The quantity of a digital asset to be sent does not exceed some limit.
The sender has export/import rights with respect to the digital asset type (e.g. gems, gold, earned, premium or non-fungible).
The receiver has export/import rights with respect to the digital asset type.

This proposed transaction may be in the form of a Smart Contract, such as those used in Ethereum or EOS. The Smart Contract may include the amounts of each digital asset or cryptocurrency, to: address, sender: address, conditions to be satisfied, execution date/time, transaction fees to be paid, and rules to apply. The Smart Contract is digitally signed by the user and gaming platform to produce hexadecimal signature values.

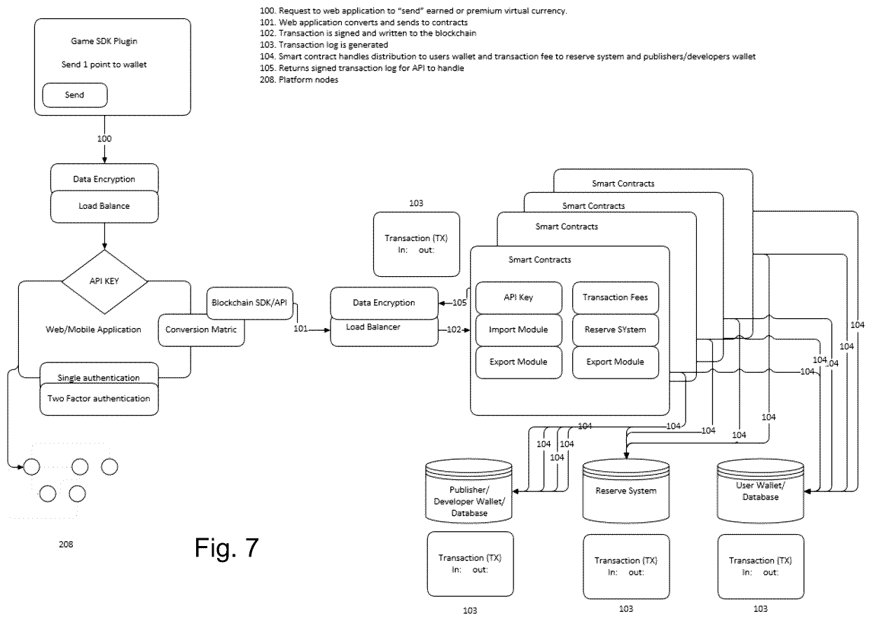

FIG. 7 illustrates exporting digital assets from the game to the distributed ledger via a transaction API. The game's transaction SDK sends request 100 to send one in-game point to the blockchain. This request is encrypted for security before calling the API on the web or mobile application. This request is sent to be stored in nodes of the transaction platform 208 and the appropriate conversion rate is found in the conversion matrix. The transaction module formats the request into the appropriate blockchain format as a contract 101. The contract is encrypted and signed by the user's and gaming platform's private keys. This is broadcast to the multiple mining nodes which agree to add the contracts as transactions 103 to the distributed ledger. The completed transactions provide updates 104 to account balances, distributed amongst users (viewed via wallets), a reserve, and game publishers/developers. The user account increases in cryptocurrency and the publisher's account decreases. The contract signs the transaction log 105, which is returned to the transaction module to confirm success or failure. If successful, the game platform removes the sent digital assets from its private ledger.

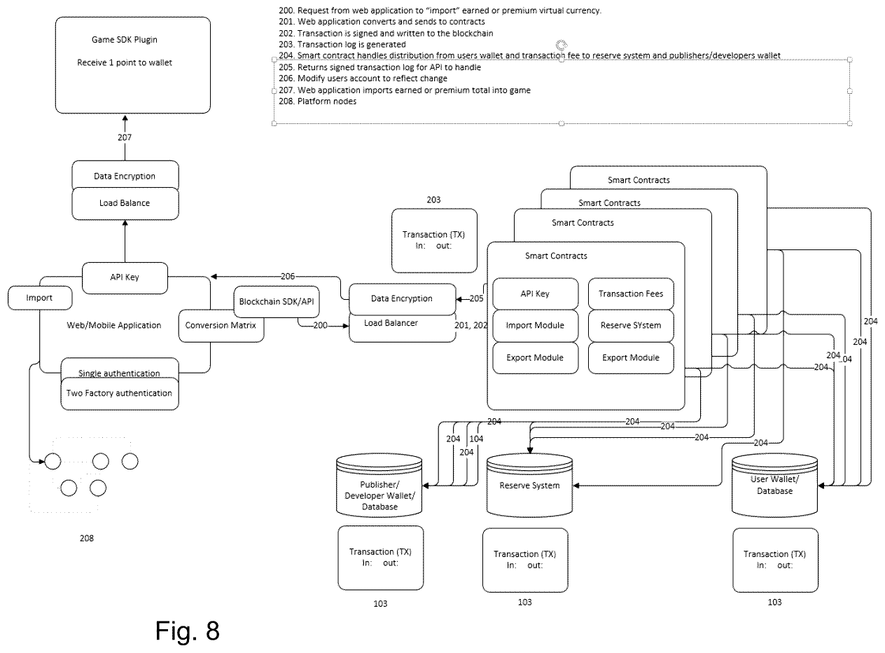

Similarly, FIG. 8 shows the reverse process of importing digital assets to the gaming platform. The web application creates a request 200 to import digital assets. As above, the conversion rate is determined 201 and requested is encrypted and signed 202 to create a smart contract 10, which is broadcast to the ledger. The smart contract is processed and, if accepted, creates a transaction 203 in the ledger. Distributions 204 cause the user's cryptocurrency balance decreases (viewed by their wallet) and the game publisher's balance to increase. A signed transaction 205 is returned to the web application, where a copy is logged by the transaction platform 208. The digital assets to be imported are encrypted and sent to the game platform, which adds those assets to the user's account on the game's private ledger.

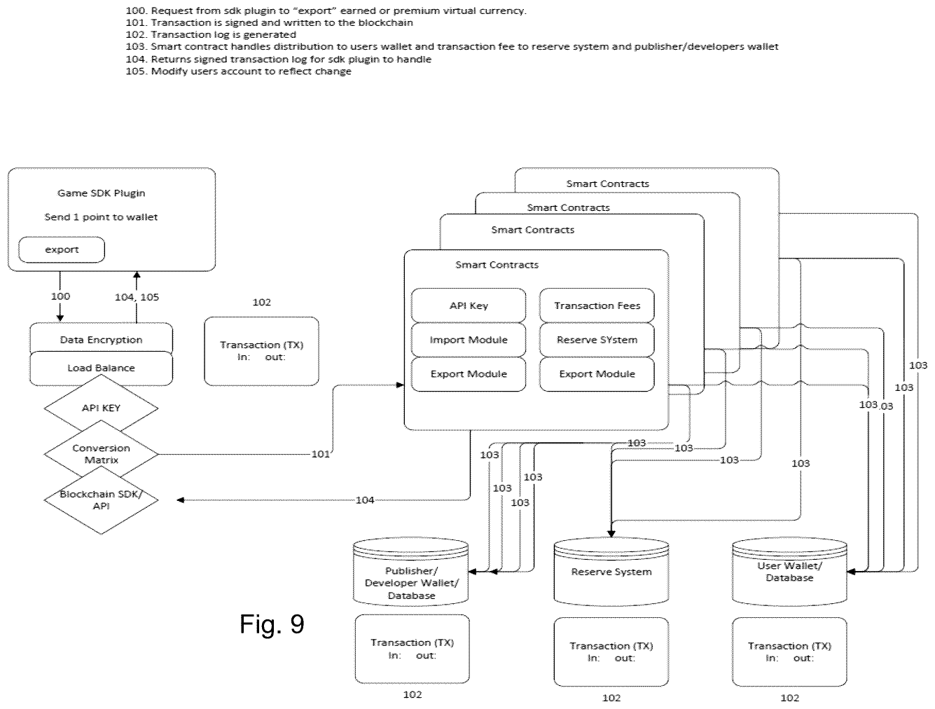

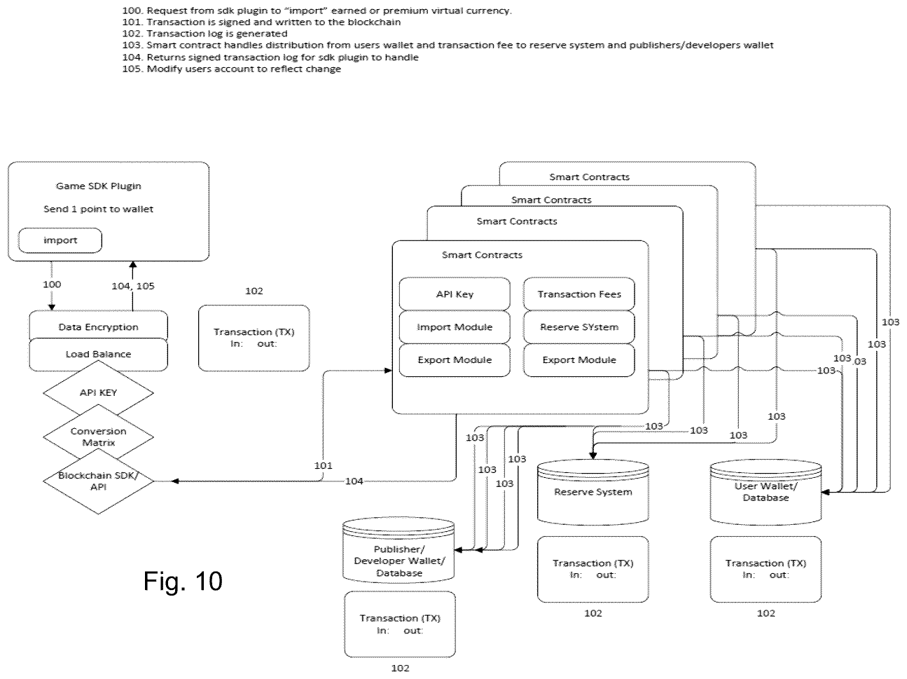

FIGS. 9 and 10 illustrate the workflow for exporting from and importing to the game, wherein the game server incorporates the transaction module to send signed, encrypted smart contracts to the ledger directly.

### Transaction Between Game Servers

In certain embodiments, the system and method enable transactions of digital assets between different games via the distributed ledger. This may be useful where exchange to a generic token tradeable on a blockchain is not desired or practical. As an example, a single digital asset might represent a certain model of car in a racing game, a wizard in an adventure game, then a tool in another game, potential becoming stronger as the asset progresses from game to game.

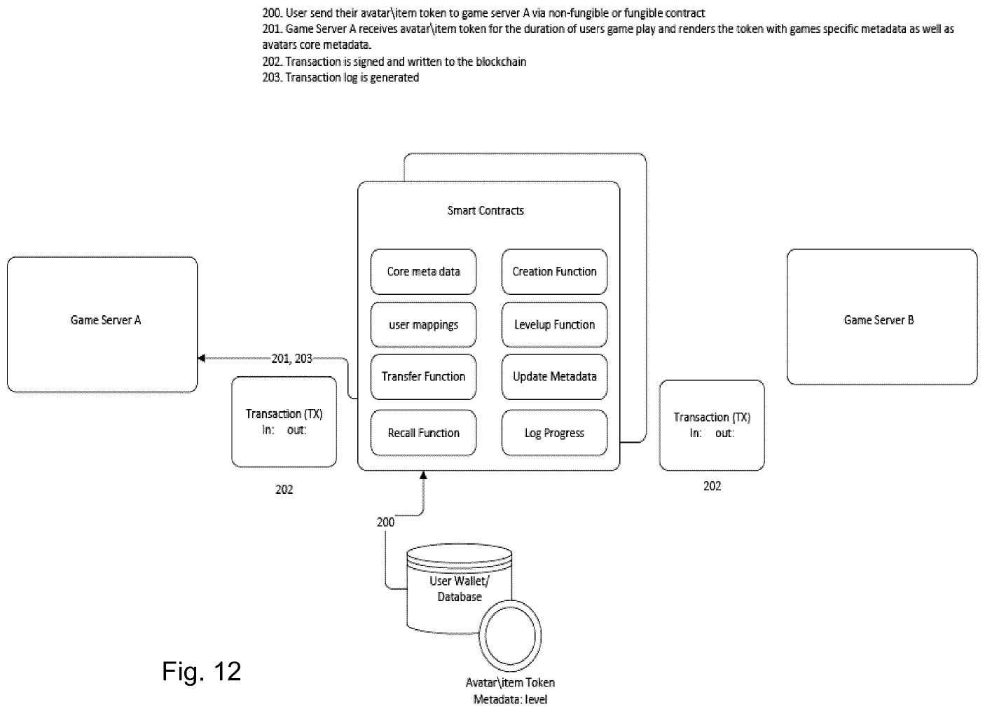

This token may exist as a smart contract, as discussed above. This token may be created by game server 4,6 or preferably by intermediary server 5. This token may initially specify the owner's public address, the common functions applicable for blockchain tokens (e.g. ERC20 in FIG. 12 and ERC721), functions for the present method, and metadata initialized to null values. Thus, the new token is capable of transactions, upgrading, and interpretation but does not represent any digital asset yet.

A user may send a selected digital asset to the distributed ledger by signing and broadcasting an export request, which has the effect of updating the Smart Contract's metadata corresponding to the digital asset's attributes and removing the digital asset from the game's ledger. Similarly, the user may transfer the token to a second game by signing and broadcasting an import request to the mining nodes. Importing both creates a new digital asset in the second game and updates the Smart Contract. One or more of the mining nodes run specific functions in the Smart Contract, to update the owner of the token, send metadata to a game platform or update the metadata.

In this embodiment, ownership of the token is associated with the user (via their public key), however the token may comprise a variable and functions to record the token as presently locked to the game in which the user is presently using the digital asset. This prevents the user from double importing the token into another game. During export, the game platform also signs the request to release the token from the previous game. The token can then be imported to a third game.

The Smart Contract may contain metadata describing the digital asset, such as power level, colour, surface pattern, originating game, asset type, rarity (or count of these tokens). The metadata may be structured as uint8-uint256 (unsigned integers), strings (UTF-8), addresses or Booleans. For example, in a 16-digit unsigned integer, the first 3 digits may classify the asset based on an FPS (first person shooter) game, with the remaining digits defining a weapon class, accuracy, damage, range, recoil.

While certain metadata may be directly convertible, such as colour, other metadata may have no corresponding meaning across games, such as weapons caliber in a car asset. Thus an interpreter module operating on each game server receives the metadata of the token transferred to that game and provides a conversion to attributes of the digital asset in that game. In the reverse direction, the interpreter may also create the metadata for a new Smart Contract that represent the digital asset when in the game. For example, certain metadata may represent a particular colour, which colour was used for a first asset in a first game (a red avatar) and will be used in a second asset of a second game (e.g. a red car).

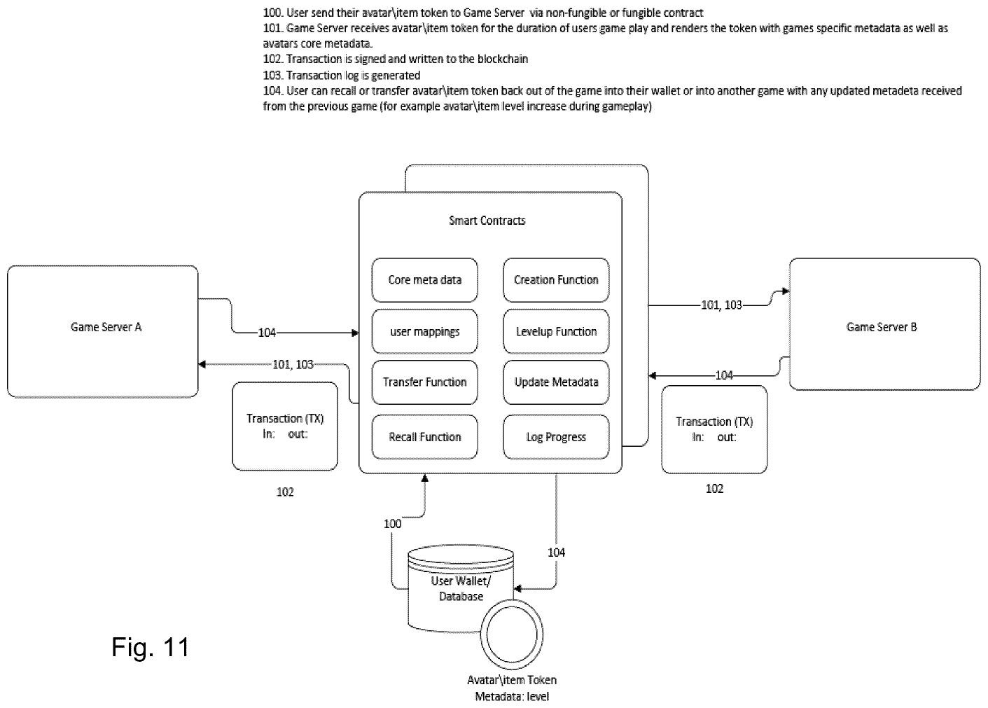

FIG. 11 shows the process of instructing a transfer of an ‘avatar’ asset via the distributed ledger to a game server. In response to a user request, the game server renders the desired metadata relevant to the token as well as relevant to that game. The user via their digital wallet signs and broadcasts request 100 to the blockchain to create a non-fungible token having that metadata. The Smart Contract comprises functions to Create, Recall, Transfer, Update and Map the avatar asset. The transaction is processed onto the blockchain and Gas is charged to the user's account. A log of the transaction is generated and sent to the user's wallet and gaming platform.

At the request of the user, the token Smart Contract is signed, and the logic is run (103) to transfer (104) to another game server to become a different digital asset. The second game server receives the token and interprets the metadata as attributes of the new digital asset in that game. Alternatively the user may recall the asset in a token (i.e. avatar, skin, or item) back to the first game.

Subsequent transactions via the distributed ledger may refer to the previous transaction or token, so that observers may view the history and upgrades made to a single asset over time. For example, a digital asset may start as a Level 1 Car in one game, later appearing as a Level 2 Wizard in the next game, then a Level 3 tool in a third game. The origin of the asset and how it has progressed provide traceability and accountability across the various game platforms.

One advantage of using a publicly viewable and trusted ledger is that the history of immutable, past transactions may be used by a game server to affect game play and future transactions. The eligibility of getting a new digital asset could depend on the state of the token's current metadata AND how the token moved between games AND what it accomplished in past games. For example, the game server(s) may provide particular rewards, open up in-game experiences, make upgrades to certain digital assets eligible, based on the history of the token and history or the digital asset in multiple games.

Each game server may operate its own Eligibility Module to determine eligibility for in-game experiences, upgrades, and rewards. The Eligibility Module could employ logic a) weighting past accomplishments/games, b) requiring at least X past events, c) requiring Y past games to determine an eligibility value from which certain in-game rewards/experience is possible. There may be a table of eligibility for each level of weighted and evaluated past games/accomplishments. A game platform's Eligibility Module may be path dependent, whereby eligibility is associated with a set of games/accomplishments in one or more pre-defined path. Eligibility may also be time-dependent. These criteria may be published to the blockchain to provide immutable criteria that any user can inspect. The eligibility criteria may be stored as a smart contract to ensure that the right to a promised eligibility is preserved. A token may comprise functions that call eligibility functions in the smart contract, which ensure that the determination of eligibility is made by impartial mining nodes publicly, which determination is sent directly to the gaming platforms.

The token may store a history of past games and game accomplishments as metadata, and the distributed ledger stores the chain of transactions between games For example, the Smart Contract's Metadata may be:

### Accomplishments:

{Game: “World of Warcraft”: Tournament X winner, CompletedGame=TRUE; Tournament Y RunnerUp;
Game: “Nascar”: Race Z winner, Race Q participant, . . . }

While the token may usually be non-fungible due to its unique metadata and history of game-to-game transactions, fungible tokens are conceived here too. This is appropriate when the digital asset embodied is a common asset with no historical dependence. That is, the fungible token is state dependent, not path dependent, and simple to interpret into a new game. This would be appropriate for building and trading a multitude of simple, common digital assets.

### Contract Code Examples

The token Smart Contract may support the following functions and data (exemplified for an Avatar asset).

```
mapping (uint => address ) public avatarToOwner;
mapping (address => uint ) public ownerAvatarCount;
mapping (address => uint ) public ownerAvatarCost;
mapping (uint => address) public avatarTransferApproved;
  function _transferToGame(address _from, address _to, uint _id) internal {
    //increase the games avatar count
    ownerAvatarCount[_to]++;
    //give temporary ownership to game
    avatarToOwner[_id] = _to;
    //check for proper owner (new avatars have no proper owner)
    if(_from != address(0)) {
      //decrease previous owner's avatar count
      ownerAvatarCount[_from]--;
      //clear the transfer approval
      delete avatarTransferApproved[_id];
    }
    //emit Transfer event
    Transfer(_from, _to, _id);
  }
Powering up an avatar/item
function levelUp(uint _id) public payable whenNotPaused {
    require(_owns(msg.sender, _id) || msg.sender == ceoAddress);
    require(msg.value == (avatars[_id].powerLevel * levelUpFee) + baseLevelCost);
    avatars[_id].powerLevel++;
  }
Updateable token metadata
struct Avatar/Item {
    uint8[ ] dna;
    uint16[ ] styles;
    uint64 creationTimestamp;
    uint8 powerLevel;
  }
event NewAccomplishment(uint gameId, address gameServer, address gamer);
function _createAccomplishment(uint256 _id, address _gameServer, address _gamer)
public (uint) {
uint id = accomplishments.push(Accomplishment(_type, _game, uint64(now), 1)) − 1;
//emit the newAvatar event
NewAccomplishment(id, _gameServer, _gamer);
}
function updateAccomplishments(uint256 _id, uint256 _type, uint16 _newValue) public {
require(_owns(msg.sender, _id) || msg.sender == gameAdmin);
token[_id].accomplishments[_type] = _ newValue;
}
```

In the above example code, the Smart Contract keeps track of a user's accomplishments. The NewAccomplishment function is an event that runs whenever a user has achieved an accomplishment as determined by the game server (for example, a league or tournament win). The function then creates the accomplishment log (address of game server, address of gamer, owner of the erc721 or erc720 token). The updateAccomplishment function tracks a particular accomplishment having different stages, by updating the log. For example, in an Olympic-type game, a user may start out with bronze in the 100 meter race and then next time get gold. The system wouldn't need to create a new accomplishment, but just update the previous, as the accomplishment data is for the same game and same event).

### Limits

One important feature and advantage of the present system is reducing fraud and hacking of game systems by imposing limits on transactions. The transaction module or ledger rules may limit the quantity of a given digital asset that each user may transact at a time, per period or time, or lifetime. The limit may increase with time after a game is released or with in-game hours played to model the expectation that users build up digital assets slowly through game play. Thus the Transaction Module may check a proposed transaction against limits stored in memory and with reference to past transactions on the distributed ledger in order to block or allow it.

In one embodiment, the conversion rates are stored in a table. The table provides look-up values for each game's assets (earned and premium currency and potentially each non-fungible asset) against which are stored rates for exporting that asset to the distributed ledger and importing that asset to the game. There may be only one rate per digital asset, but two rates allow for a currency spread to reward certain operators within the system such as miners. Moreover, the rates for a particular digital asset may be dynamically updated based on the number of that asset in circulation or ever distributed, age of the game since release, promotions. For example, in importing virtual gems a game, early players may receive a promotional rate of 100 gems per token, declining to 50 gems per token as the game is popularized, then rising to 1000 gems per token once the game has past its prime. The corresponding export-from-game rate may be initially low to stop players leaving the game prematurely, rising to 55 gems during the popular period, before rising to 5000 gems per token to make old games effectively unrewarded.

The limits and conversion rates may be administered and set by each gaming platform. In certain embodiments, the limits and rates may be initially declared by the game platform and codified within the ledger rules so as to make them transparent to user and provide assurance of future worth. This may be implemented as a Smart Contract signed by the game platform, enabling any user to call the Contract to create a conversion, provided that the user pays the gas, owns the digital asset or token to be converted and complies with limits and rules of the Contract, wherein the conversion rate is programmed and stored in the Contract.

### Encryption/Signing

In certain embodiments, double encryption is used to improve security by encrypting messages sent from the game to transaction server and again from transaction server to blockchain.

Digital signatures ensure that the relevant parties can prove that only they are the ones requesting a transaction and cannot repudiate it later. In certain embodiment, the digital signature is based on RSA. To create signature keys, an RSA key pair is generated containing a modulus, N, that is the product of two random secret distinct large primes, along with integers, e and d, such that e d≡1 (mod φ(N)), where q is the Euler phi-function. The signer's public key consists of N and e, and the signer's private key contains d. To sign a message, m, the signer computes a signature, σ, such that σ≡md (mod N). The signature is verified by other computers (such as mining nodes) by checking that σe≡m (mod N).

1. A computer-implemented method for gaming transactions, the method comprising:
a) determining that a user is eligible for an in-game, non-fungible, digital asset based on user game play;
b) creating a transaction message including data about the non-fungible digital asset and public identifier of the user; and
c) broadcasting the transaction message to multiple computing nodes to incorporate the transaction offer into a distributed ledger.

2. The method of claim 1, wherein the message further includes an amount of cryptocurrency to be sent by the user in exchange for the non-fungible digital asset.

3. A computer-implemented method for transacting digital assets on a blockchain accessed by multiple gaming platforms, the method comprising:
exporting a first in-game digital asset from a first game platform to a token on the blockchain;
importing the token to a second in-game digital asset on a second game platform, different from the first platform; and
interpreting metadata in the token into attributes of the digital asset.

4. The method of claim 3, wherein the token is structured as a Smart Contract comprising functions for handling ownership of the token and metadata representing attributes of the digital assets.

5. The method of claim 3, wherein exporting the first in-game digital asset comprises setting metadata of the token based on attributes of said digital asset.

6. The method of claim 3, further comprising determining eligibility of user for in-game rewards, experience, or digital assets based on past transaction of the token.

7. The method of claim 3, further comprising interpreting attributes of the digital assets in the second game based on past transaction of the token.

8. The method of claim 3, wherein the token comprises:
metadata representing attributes of digital assets in a game;
an ownership variable storing the public key of a user;
a second ownership variable storing the public key associated with the game; and
functions for importing and exporting the metadata to and from games.

9. The method of claim 3, wherein the token comprises functions for updating the ownership variables and metadata.

10. A system for transacting digital assets between computer games, comprising:
a blockchain data structure distributed amongst a multiple computing nodes;
a token data structure storing metadata and instructions for processing transactions of a token on the blockchain; and
one or more gaming platforms, each platform comprising at least one processor and instructions, which instructions are configured to:
a) broadcast an export request from a user to the multiple computing nodes, the export request comprising a request to update a specified token's metadata with data representing attributes of a digital asset of a first game;
b) broadcast an import request from the user to import the token's metadata to a second game, different from the first game;
c) interpret the token's metadata as attributes of a second digital asset in the second game; and
d) operate the second game for the user using the second digital asset.

11. The system of claim 10, wherein the import requests is cryptographically signed by the user, the user registered as an owner of the token.

12. The system of claim 10, further comprising determining eligibility of user for in-game rewards, experience, or digital assets based on past transaction of the token.

13. The system of claim 10, further comprising interpreting attributes of the digital assets in the second game based on past transaction of the token.

14. The system of claim 10, further comprising locking the token after the token is imported to the second game by setting a second ownership variable to the public key associated with that second game, until the second game provides a signed request to unlock the token.
